(19) United States
(12) Patent Application Publication
(10) Pub. No.: US 2020/0126541 A1
(43) Pub. Date: Apr. 23, 2020

(54) Phonetic Representor, System, and Method

(71) Applicant: Copytalk LLC, Sarasota, FL (US)

(72) Inventors: Baird Juckett, Sarasota, FL (US); Darren Andrews, Gainesville, FL (US); Brian Johnson, Bradenton, FL (US); Jason Kimble, Bradenton, FL (US)

(73) Assignee: Copytalk, LLC, Sarasota, FL (US)

(21) Appl. No.: 16/657,024

(22) Filed: Oct. 18, 2019

Related U.S. Application Data
(60) Provisional application No. 62/748,402, filed on Oct. 20, 2018.

(51) Int. Cl. G10L 15/187; G10L 15/22; G10L 15/30; G10L 15/18; G06F 3/16; G06F 21/60

(52) U.S. Cl. CPC G10L 15/187; G10L 15/22; G10L 15/30; H04L 63/0442; G06F 3/167; G06F 21/602; G10L 15/1815

(57) ABSTRACT

The present invention comprises a phonetic representor comprising a graphical controller used to initiate a phonetic session at an application, an audio capturer which initiates and stores a recording of the phonetic session, an audio data sequence, an audio data sequence sender to send the data sequence to an audio data sequence receiver at a transcription workstation, an audio data sequence player for playing the one audio data sequence which a transcriber transcribes into a written data sequence, a written data sequence sender to send the written data sequence to a written data sequence receiver at the application, a populator which analyzes the written data sequence and incorporates it at the application, and a controller comprising an operating system to direct and control the invention, a coupler to connect the various elements via a gateway, and a multimodal input component to receive input from the user.

### CLAIM OF PRIORITY TO PROVISIONAL PATENT APPLICATION

This application claims the benefit of priority under 35 U.S.C. § 119(e) of U.S. Provisional Patent Application Ser. No. 62/748,402, filed Oct. 20, 2018, and entitled “Phonetic Representor, System, and Method,” which is incorporated by reference as if set forth herein in its entirety.

### FIELD OF THE INVENTION

The field of the invention comprises speech recognition, transcription of phonetics to text, and applications associated with such.

### BACKGROUND OF THE INVENTION

One area of technology which is ever evolving is voice-to-text and/or speech recognition software. Voice-to-text is a type of speech recognition program that electronically converts spoken to written language. Voice-to-text was originally developed as an assistive technology for the hearing impaired, the applications limited primarily because generally voice-to-text programs had to be “trained” to recognize a specific person's speech before attaining an acceptable level of accuracy. Speech recognition is one of the inter-disciplinary sub-fields of computational linguistics intended for the development of methodologies and technologies that enable the recognition and translation of spoken language into text by computers. A majority of current speech recognition systems still require training (also called “enrollment”), where a user (i.e., individual speaker) must read text or isolated vocabulary into the system before it will operate properly. The systems generally can analyze a user's specific voice and use it to fine-tune the recognition of that user's speech, resulting in increased accuracy, however, the accuracy is often times not satisfactory to an ordinary user.

Therefore, reliable devices, systems, and methods are needed to be able to provide voice transcription services with improved accuracy.

### SUMMARY OF THE INVENTION

It is, therefore, an object of the present invention to provide a phonetic representor, a system comprising as one element a phonetic representor, and a method of the functionality of such phonetic representor and system.

The present invention may optionally operate within a number of communications and/or network environments, for example, but in no way limited to, the public Internet, a private Internet or Intranet, wireless or mobile phone connection or system, a network on one side of a third-party provided address family translation or network address translation (NAT) implementation, a network on a second side of a third-party provided NAT implementation, a data transport network or a series of networks, a communications network or series of networks, a non-optimized communications network or series of networks, an optimized communications network or series of networks, and the like.

In one exemplary embodiment, a phonetic representor is provided. The phonetic representor can further comprise a graphical controller, an audio capturer, an audio data sequence sender, an audio data sequence receiver, an audio data sequence player, a written data sequence sender, a written data sequence receiver, a populator, and a controller, all coupled in an asynchronous manner.

In one exemplary aspect of the present embodiment, the graphical controller can allow a user to initiate a phonetic session by activating the graphical controller. The graphical controller can be integrated into an application.

In another exemplary aspect of the present embodiment, the audio capturer can initiate and can optionally store a recording of the phonetic session. The recording of the phonetic session can be an audio data sequence.

In yet another exemplary aspect of the present embodiment, the audio data sequence sender can send the audio data sequence, whether or not stored, to the audio data sequence receiver at a transcription workstation.

In yet still another exemplary aspect of the present embodiment, the audio data sequence player can play the audio data sequence at the transcription workstation and a transcriber can transcribe the audio data sequence into a written data sequence.

In yet a further exemplary aspect of the present invention, the written data sequence sender can send the written data sequence from the transcription workstation to the written data sequence receiver at the application

In still another exemplary aspect of the present invention, the populator can analyze the received written data sequence and can incorporate the written data sequence at the application.

In still a further exemplary aspect of the present invention, the controller can further comprise an operating system, a coupler, and a multimodal input component.

In yet still another exemplary aspect of the present embodiment, the operating system can direct and control the operation and function of the present embodiment via a network.

In another exemplary aspect of the present embodiment, the coupler can operatively couple the graphical controller, the audio capturer, the audio data sequence sender, the audio data sequence receiver, the written data sequence sender, the written data sequence receiver, and the populator, via a network and a gateway.

In a last exemplary aspect of the present embodiment, the multimodal input component can receive a multimodal input from the user via the network, upon triggering of the present embodiment.

The following are either or both additional and exemplary aspects of the present exemplary embodiment, one or more of which can be combined with the basic inventive phonetic representor embodied above:
the graphical controller can further comprise a unique identifier collector, the unique identifier collector being able to collect a series of data elements that uniquely identify the phonetic session initiated by the user;
the series of data elements can further comprise a second series of data elements which uniquely identifies a context of the phonetic session;
the series of data elements can further comprise an application specific identifier which uniquely identifies the phonetic session;
the series of data elements does not comprise any series of data elements which identify the user who initiates the phonetic session;
the transcriber can receive as part of the audio data sequence a visual form dictated by the series of data elements that uniquely identify the phonetic session;
the graphical controller can be integrated into the application via an application programming interface specific to the application;
the audio capturer can further comprise an application programming interface which facilitates using a native browser communication collection feature;
the audio capturer can further comprise an integrator further comprising a second application programming interface which can allow communication between the native browser communication collection feature and the multimodal input component;
the audio data sequence sender can further comprise an encryptor which can encrypt the audio data sequence prior to sending to the audio data sequence receiver; the transcriber can transcribe the audio data sequence into the written data sequence in an asynchronous manner;
the populator can analyze the written data sequence at the application based on a mapping feature of the application;
the populator can analyze the written data sequence at the application based on the context that uniquely identifies the phonetic session; and the written data sequence can be transmitted by the written data sequence sender in the same format and order as if entered into the application directly by the user in that format and order.

In another exemplary embodiment, a system comprising as one element a phonetic representor is provided. The system can further comprise an at least one user device, an at least one application, an at least one transcription workstation, an at least one transcriber, a network, and the phonetic representor.

In one exemplary aspect of the present embodiment, a user via the user device can initiate a phonetic session by activating a graphical controller integrated into the application.

In another exemplary aspect of the present embodiment, an audio capturer can initiate and store a recording of the phonetic session. The phonetic session can comprise an audio data sequence.

In yet another exemplary aspect of the present embodiment, an audio data sequence sender can send the audio data sequence to an audio data sequence receiver at the transcription workstation.

In yet still another exemplary aspect of the present embodiment, the transcriber can play, via an audio data sequence player at the transcription workstation, the audio data sequence and can transcribe the audio data sequence into a written data sequence.

In still another exemplary aspect of the present embodiment, from the transcription workstation, a written data sequence sender can send the written data sequence to a written data sequence receiver at the application.

In still a further exemplary aspect of the present embodiment, a populator can analyze the written data sequence and can incorporate the written data sequence at the application.

In a further exemplary aspect of the present embodiment, a controller can further comprise an operating system, a coupler, and a multimodal input component.

In yet another exemplary aspect of the present embodiment, the operating system can, via the network, direct and control the operation and function of the phonetic representor.

In still another exemplary aspect of the present embodiment, the coupler can operatively couple the graphical controller, the audio capturer, the audio data sequence sender, the audio data sequence receiver, the written data sequence sender, the written data sequence receiver, the populator, the at least one application, the at least one transcription workstation, and the at least one transcriber, via an at least one gateway.

In another exemplary aspect of the present embodiment, the multimodal input component can receive a multimodal input from the user operating the at least one user device once the phonetic representor is triggered.

The following are either or both additional and exemplary aspects of the present exemplary embodiment, one or more of which can be combined with the basic inventive system embodied above:
the graphical controller can further comprise a unique identifier collector, the unique identifier collector being able to collect a series of data elements that uniquely identify the phonetic session initiated by the user; the series of data elements can further comprise a second series of data elements which uniquely identifies a context of the phonetic session;
the series of data elements can further comprise an application specific identifier which uniquely identifies the phonetic session;
the series of data elements does not comprise any series of data elements which identify the user who initiates the phonetic session;
the transcriber can receive as part of the audio data sequence a visual form dictated by the series of data elements that uniquely identify the phonetic session;
the graphical controller can be integrated into the application via an application programming interface specific to the application;
the audio capturer can further comprise an application programming interface which facilitates using a native browser communication collection feature;
the audio capturer can further comprise an integrator further comprising a second application programming interface which can allow communication between the native browser communication collection feature and the multimodal input component;
the audio data sequence sender can further comprise an encryptor which can encrypt the audio data sequence prior to sending to the audio data sequence receiver; the transcriber can transcribe the audio data sequence into the written data sequence in an asynchronous manner;
the populator can analyze the written data sequence at the application based on a mapping feature of the application;
the populator can analyze the written data sequence at the application based on the context that uniquely identifies the phonetic session; and
the written data sequence can be transmitted by the written data sequence sender in the same format and order as if entered into the application directly by the user in that format and order.

Lastly, a method for transcribing an audio data sequence captured via a phonetic representor is provided. The steps of the method described below can occur in any functionally operable order, concurrently, simultaneously, or in any other synchronous or asynchronous manner which would optimally provide the desired accuracy and ease of use for a user.

In one exemplary aspect of the present embodiment, the user can activate a phonetic session, via a graphical controller, by clicking the graphical controller integrated into an application.

In another exemplary aspect of the present embodiment, the audio data sequence can be recorded via the audio data capturer, which the audio capturer can initiate and store the recorded phonetic session comprising the at least one audio data sequence.

In still another exemplary aspect of the present embodiment, the audio data sequence can be sent, via an audio data sequence sender, to an audio data sequence receiver at a transcription workstation.

In yet another exemplary aspect of the present embodiment, a transcriber can play the received audio data sequence, via an audio data sequence player, and thereafter transcribe the audio data sequence into a written data sequence.

In yet still another exemplary aspect of the present embodiment, the written data sequence can be sent, via a written data sequence sender, from the transcription workstation to a written data sequence receiver at the application.

In still a further exemplary aspect of the present embodiment, the written data sequence can be populated at the application, via a populator. The populator can analyze the written data sequence and can incorporate the written data sequence at the application.

The following are either or both additional and exemplary aspects of the present exemplary embodiment, one or more of which can be combined with the basic inventive method embodied above:
the graphical controller can further comprise a unique identifier collector, the unique identifier collector being able to collect a series of data elements that uniquely identify the phonetic session initiated by the user;
the series of data elements can further comprise a second series of data elements which uniquely identifies a context of the phonetic session;
the series of data elements can further comprise an application specific identifier which uniquely identifies the phonetic session;
the series of data elements does not comprise any series of data elements which identify the user who initiates the phonetic session;
the transcriber can receive as part of the audio data sequence a visual form dictated by the series of data elements that uniquely identify the phonetic session;
the graphical controller can be integrated into the application via an application programming interface specific to the application;
the audio capturer can further comprise an application programming interface which facilitates using a native browser communication collection feature;
the audio capturer can further comprise an integrator further comprising a second application programming interface which can allow communication between the native browser communication collection feature and a multimodal input component;
the audio data sequence sender can further comprise an encryptor which can encrypt the audio data sequence prior to sending to the audio data sequence receiver;
the transcriber can transcribe the audio data sequence into the written data sequence in an asynchronous manner;
the populator can analyze the written data sequence at the application based on a mapping feature of the application;
the populator can analyze the written data sequence at the application based on the context that uniquely identifies the phonetic session; and the written data sequence can be transmitted by the written data sequence sender in the same format and order as if entered into the application directly by the user in that format and order.

These and other exemplary aspects of the present basic inventive concept are described below. Those skilled in the art will recognize still other aspects of the present invention upon reading the included detailed description.

### DETAILED DESCRIPTION OF THE DRAWINGS

The present invention is illustrated by way of example, and not limitation, in the figures depicted in the following drawings.

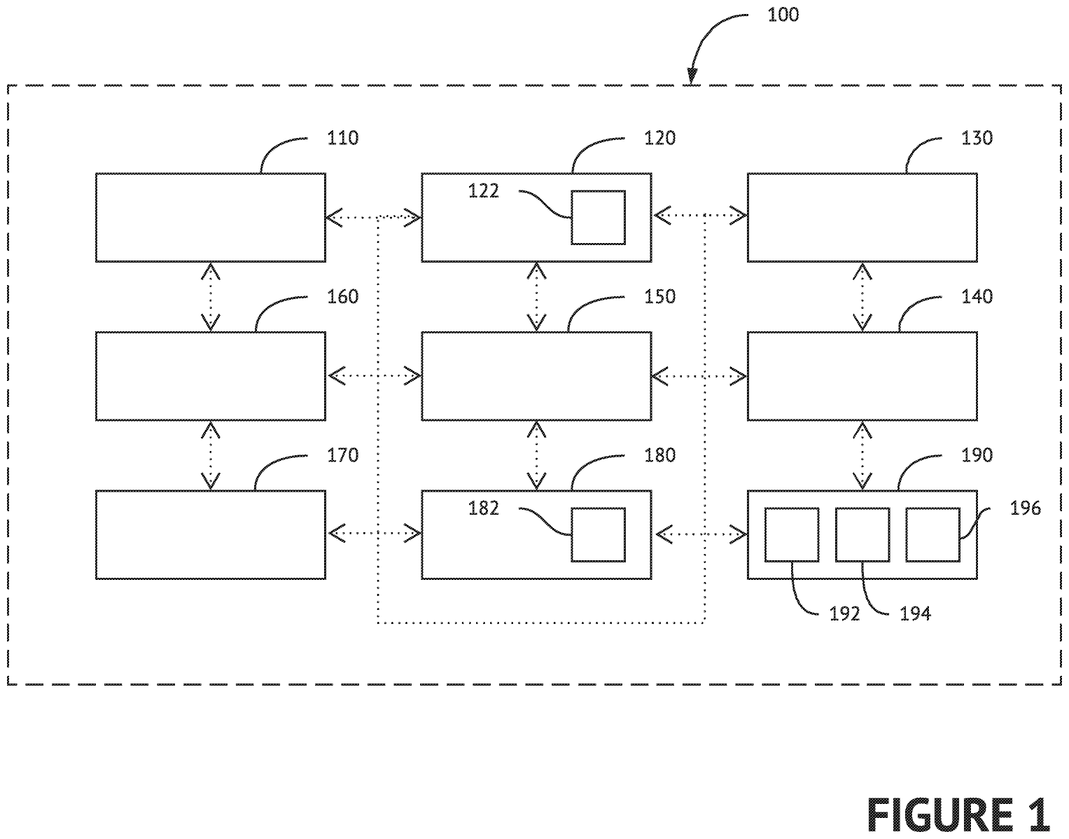

FIG. 1 illustrates an exemplary embodiment of the present invention, an exemplary phonetic representor.

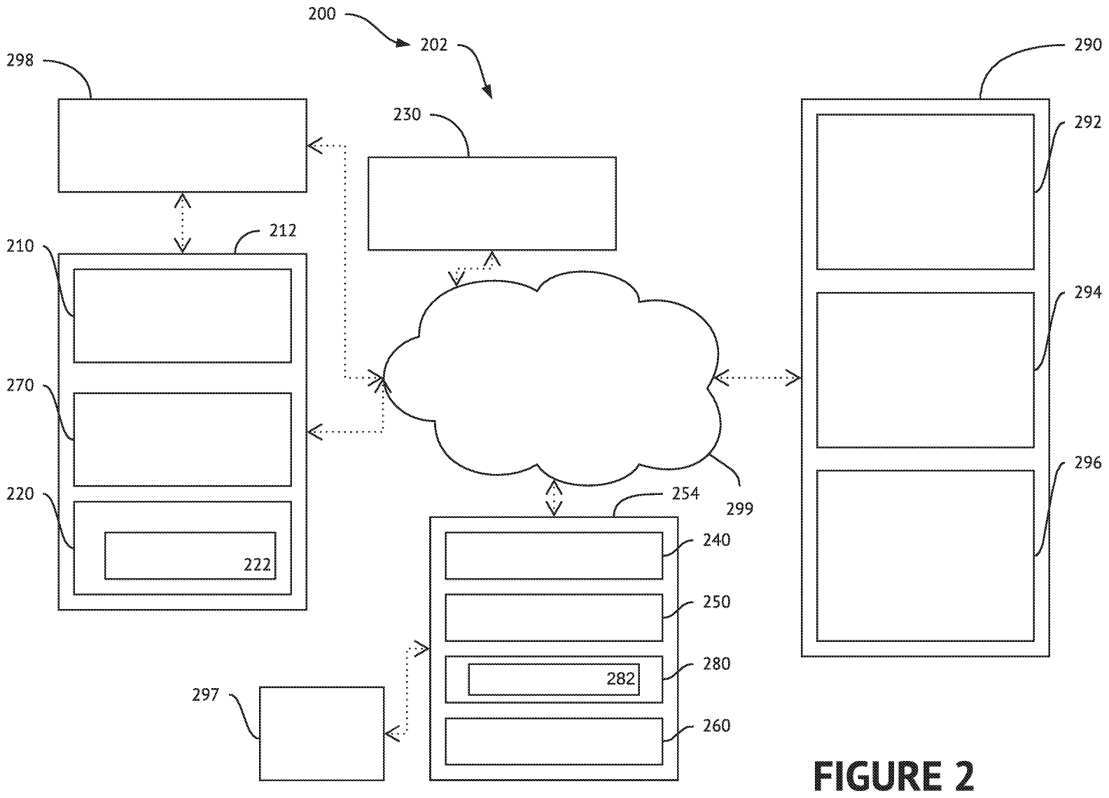

FIG. 2 illustrates one exemplary embodiment of the present invention, a system, in which a phonetic representor may be a functional element.

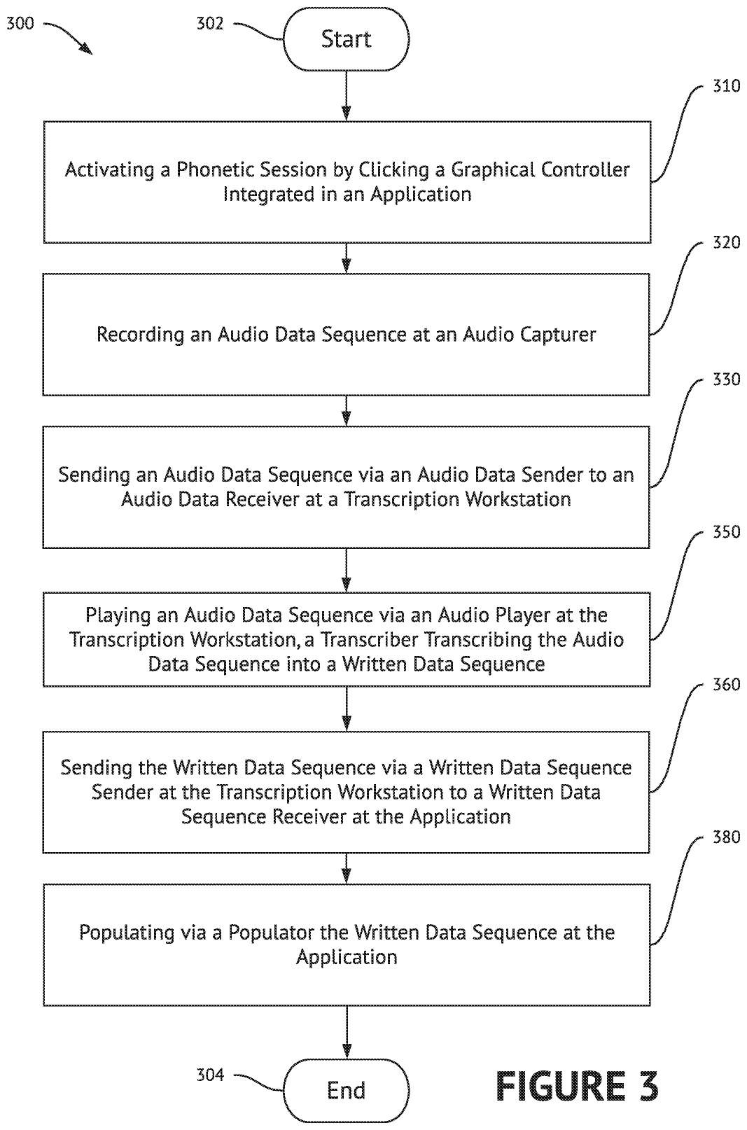

FIG. 3 illustrates one exemplary aspect of the present invention, an exemplary method for transcribing an audio data sequence using a phonetic representor.

### DETAILED DESCRIPTION OF THE INVENTION

The present invention will now be described more fully herein with reference to the accompanying drawings, which form a part of, and which show, by way of illustration, specific exemplary embodiments through which the invention may be practiced. This invention may, however, be embodied in many different forms and should not be construed as limited to the exemplary embodiments set forth below. Rather, these exemplary embodiments are provided so that this disclosure will be thorough and complete, and will fully convey the scope of the invention to those skilled in the art. Among other things, the present invention may be embodied as devices, systems, and methods. Accordingly, various exemplary embodiments may take the form of entirely hardware embodiments, entirely software embodiments, and embodiments combining software and hardware aspects. The following detailed description, is, therefore, not to be taken in a limiting sense.

Throughout this specification and claims, the following terms take the meanings explicitly associated herein, unless the context clearly dictates otherwise. The phrases “in one embodiment” and “this exemplary embodiment” do not necessarily refer to the same embodiment, though they may. Furthermore, the phrases “in another embodiment,” “additional embodiments,” and “further embodiments” do not necessarily refer to each or collectively to a different embodiment, although they may. As described below, various embodiments of the invention may be readily combined, without departing from the scope or spirit of the invention.

In addition, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.” Also, throughout the specification, the term “comprise” and its conjugations and the term “include” and its conjugations may be used interchangeably unless the context clearly dictates otherwise. In addition, the phrases “at least one” and “one or more” do not necessarily limit the referred to the element, and the failure to use these phrases is not intended to limit the number of elements. However, these terms and phrases are used throughout the claims with the intended purpose and meaning as ascribed to them in the Manual of Patent Examining Procedure.

The following briefly describes one of the exemplary embodiments of the present invention, in order to provide a basic understanding of some aspects of the invention. This brief description is not intended as an extensive overview, nor is it intended to identify key or critical elements, to delineate, or otherwise, narrow the scope. Its purpose is simply to present concepts in a simplified form as a prelude to a more detailed description which is presented later. The present invention, generally, is directed towards a hardware computing solution which comprises a series of coupled computing elements which when functioning together comprise a phonetic representor. These elements include but are not limited to a graphical controller used to initiate a phonetic session at an application, an audio capturer which initiates and stores a recording of the phonetic session, an audio data sequence, an audio data sequence sender to send the data sequence to an audio data sequence receiver at a transcription workstation, an audio data sequence player for playing the one audio data sequence which a transcriber transcribes into a written data sequence, a written data sequence sender to send the written data sequence to a written data sequence receiver at the application, a populator which analyzes the written data sequence and incorporates it at the application, and a controller comprising an operating system to direct and control the invention, a coupler to connect the various elements via a gateway, and a multimodal input component to receive input from the user.

In a non-limiting sense, a user activates the phonetic representor by clicking the graphical controller which can be integrated into any number of applications which the user frequently adds content. Upon activation, the user would begin a phonetic session, i.e., begin dictating content to include in the application. This phonetic session is recorded as an audio data sequence and sent via an audio data sequence sender to an audio data sequence receiver at a transcription workstation. A transcriber plays or listens to the audio data sequence, by engaging the audio data sequence player, and transcribes it into a written data sequence, and thereafter transmits the written data sequence via a written data sequence sender to a written data sequence receiver at the application. A populator coupled to the application may analyze the written data sequence and may further format the written data sequence, based optionally upon an a variety of unique identifiers, populating the written data sequence into key data fields or locations directly within the application, as discussed in more detail below.

An application (application or “app”) can generally be defined as a computer program designed to perform a group of coordinated functions, tasks, or activities for the benefit of a user to operate a device. Examples of the application include a word processor, a spreadsheet, an account application, a web browser, a media player, a console game, a photo editor, and the like. The collective noun “application software” or “device software” refers to all applications collectively operating by the functionality of an associated computing device. This contrasts with system software, which is mainly involved in running computing hardware.

Applications may be bundled within a computer device and its system software or published separately and may be coded as proprietary, open source, and/or a combination.

Below, exemplary embodiments will be provided in conjunction with the attached drawings. The written description below will begin with reference to FIG. 1, which will discuss various aspects of an exemplary embodiment of the phonetic representor. FIG. 2 will discuss various elements of an exemplary embodiment of a system incorporating the phonetic representor. FIG. 3 will discuss various aspects associated with an exemplary methodology of how the phonetic representor functions. Along with each figure, discussion will be included about various additional embodiments of the present invention.

FIG. 1 illustrates one exemplary embodiment, a phonetic representor 100. A Generally, phonetic representor 100 may be defined as a loose coupling of commuting components and elements which together comprise a device that serves to express, designate, stand for, or denote, as a written word, symbol, or the like; symbolize or embody in writing a phonetic session. As further illustrated in FIG. 1, phonetic representor 100 can further comprise a graphical controller 110, an audio capturer 120, an audio data sequence sender 130, an audio data sequence receiver 140, an audio data sequence player 150, a written data sequence sender 160, a written data sequence receiver 170, a populator 180, and a controller 190.

Graphical controller 110 can allow a user to initiate a phonetic session by activating graphical controller 110. A phonetic session may generally be defined as a single continuous course or a period of speech sounds. Activation, for purposes of this specification and claims, can include any number of methodologies for activation, including but not limited to, clicking a graphical controller 110 icon, speaking or cueing in another fashion for graphical controller 110 to activate, and the like. Generally, graphical controller 110 can be an “integrated” component, i.e., a controlling element incorporated or built into an application or device. Integration or system integration may generally be defined in device development and computer-based engineering as the process of bringing together the component sub-systems into one system (an aggregation of subsystems cooperating so that the system is able to deliver the overarching functionality) and ensuring that the subsystems function together as a system, and in information technology as the process of linking together different computing systems and software applications physically or functionally, to act as a coordinated whole.

In product or device development, a user (sometimes “end-user”) can generally be defined as a person who ultimately uses or is intended to ultimately use a product or application. The user stands in contrast to users who support or maintain the product or application, such as sysops, system administrators, database administrators, information technology experts, software professionals, and computer technicians. Users typically do not possess the technical understanding or skill of the product designers. In information technology, users are not “customers” in the usual sense-they are typically employees of the customer. For example, if a large retail corporation buys a software package for its employees to use, even though the large retail corporation was the “customer” which purchased the software, the users are the employees of the company who will use the software.

One example of an integration methodology is vertical integration, which may generally be defined as the process of integrating subsystems according to their functionality by creating functional entities also referred to as silos. The benefit of this method is that the integration is performed quickly and involves only the necessary components, therefore, this method is cheaper in the short term. On the other hand, cost-of-ownership can be substantially higher than seen in other methods, since in case of new or enhanced functionality, the only possible way to implement (i.e., scale the device or system) would be by implementing another silo. Reusing subsystems to create another functionality is not possible.

Another example of an integration methodology is star integration, also known as spaghetti integration, which generally is a process of systems integration where each system is interconnected to each of the remaining subsystems. When observed from the perspective of the subsystem which is being integrated, the connections are reminiscent of a star, but when the overall diagram of the system is presented, the connections look like spaghetti. In a case where the subsystems are exporting heterogeneous or proprietary interfaces, the integration cost can substantially rise. Time and costs needed to integrate the systems increase exponentially when adding additional subsystems. From the feature perspective, this method often seems preferable, due to the extreme flexibility of the reuse of functionality.

Another example of integration methodology is horizontal integration or “Enterprise Service Bus” (ESB), which is an integration method in which a specialized subsystem is dedicated to communication between other subsystems. This allows cutting the number of connections (interfaces) to only one per subsystem which will connect directly to the ESB. The ESB can be developed to be functionally capable of translating the interface into another interface. With systems integrated using this method, it is possible to completely replace one subsystem with another subsystem which provides similar functionality but exports different interfaces, all this completely transparent for the rest of the subsystems. The only action required is to implement the new interface between the ESB and the new subsystem.

Additional embodiments are contemplated where graphical controller 110 can be integrated into the application via an application programming interface specific to the application. An application programming interface (API) is commonly characterized as a set of subroutine definitions, protocols, and tools for building application software. In general terms, it is a set of clearly defined methods of communication between various software or hardware components. A good API makes it easier to develop a computer program by providing all the building blocks, which are then put together by the programmer. An API may, in one example, be for a web-based system, operating system, database system, computer hardware, software library, or the like. An API specification can take many forms, but often includes specifications for routines, data structures, object classes, variables or remote calls. POSIX, Microsoft Windows API, the C++ Standard Template Library and Java APIs are examples of different forms of traditional APIs. APIs, in another example, may be considered proprietary by their creators due to the unique nature of the function and purpose of the particular API.

Just as a graphical user interface makes it easier for people to use programs, application programming interfaces make it easier for developers to use certain technologies in building applications. By abstracting the underlying implementation and only exposing objects or actions the developer needs, an API simplifies programming.

In FIG. 1, graphical controller 110 may comprise a control element (sometimes called a control or widget), i.e., a graphical user interface element of interaction, such as a button or a scrollbar. A user interface (UI) feature is frequently characterized as a space where interactions between humans and machines occur. The goal of this interaction is to allow effective operation and control of the machine from the human end, whilst the machine simultaneously feeds back information that aids the operators and decision-making process. Controls are often generally defined as software components that a computing device user interacts with through direct manipulation to read or edit information about an application or device.

Graphical controller 110 may optionally facilitate a specific type of user interaction and can appear as a visible part of phonetic representor 100, defining its theme and aesthetic design, creating a sense of overall cohesion of purpose and function. Some widgets support interaction with the user, for example, labels, buttons, and checkboxes. Others act as containers that group the widgets added to them, for example, windows, panels, and tabs. As contemplated in the present embodiment, graphical controller 110 may be, but is not limited to, a button, a radio button, a checkbox, a split button, a cycle button, a slider, a list box, a spinner, include a drop-down list or menu, be a context menu, a pie menu, a menu or toolbar, a ribbon, a combo box, an icon, have a tree view, a grid view, or be a data grid, be a link, a tab, a scrollbar, a separate window, a status or progress bar, a modal window, a collapsible or accordion panel, a palette or utility window, embedded in a frame, a canvas, a cover flow, a bubble flow, or the like.

In additional embodiments, graphical controller 110 can further comprise a unique identifier collector, which may generally be defined as a computing element which flags and records a unique identifier. In this exemplary embodiment, the unique identifier collector can optionally collect a series of data elements that uniquely identify the phonetic session initiated by the user.

With reference to a given set of objects, a unique identifier (or “UID”) can be defined as any identifier which is guaranteed to be unique among all identifiers used for those objects and for a specific purpose. Generally, there are three main types of unique identifiers in computing devices or applications, each corresponding to a different generation strategy. One example includes, but is not limited, to serial numbers, assigned incrementally or sequentially random numbers selected from a number space much larger than the maximum (or expected) number of objects to be identified. Although not really unique, some identifiers of this type may be appropriate for identifying objects in many practical applications and are, with abuse of language, still referred to as “unique” names or codes allocated by choice. These methods can be combined, hierarchically or singly, to create other generation schemes which guarantee uniqueness. In many cases, a single object may have more than one unique identifier, each of which identifies it for a different purpose. In relational databases, certain attributes of an entity that serve as unique identifiers may be called “primary keys.”

In additional exemplary embodiments, the series of data elements can further comprise a second data element which uniquely identifies a context of the phonetic session. For purposes of this specification and the clams, uniquely identifies generally means to recognize or establish as being a particular person or thing; verify the identity of; to serve as a means of identification for; or to make, represent to be, or regard or treat as the same or identical.

In further exemplary embodiments, the series of data elements can further comprise an application specific identifier which uniquely identifies the phonetic session. In yet still additional embodiments, the series of data elements do not need to comprise any data elements which identify the user who initiates the phonetic session. Examples of these types of data elements may include but are not limited to personally identifiable information (PII), call detail records (CDRs), and the like.

As further illustrated in FIG. 1, audio capturer 120 can initiate and can optionally store a recording 122 of the phonetic session. Recording 122 of the phonetic session can be an audio data sequence. In digital recording, audio signals picked up by a microphone or other transducer or video signals picked up by a camera or similar device can be converted into a stream of discrete numbers, representing the changes over time in air pressure for audio, and chroma and luminance values for video, then recorded to a storage device. To play back a digital sound recording, in one example, numbers can be retrieved and converted back into their original analog waveforms so that they can be heard through a speaker. To play back a digital video recording, in another example, numbers can be retrieved and converted back into their original analog waveforms so that they can be viewed on a video monitor or other display.

In additional embodiments, audio capturer 120 can further comprise an application programming interface which facilitates using a native browser communication collection feature.

One example of a native browser communication collection feature includes, but is not limited to the Media Capture and Streams API, often called the “Media Stream API” or the “Stream API.” This API is related to WebRTC, which is an open-source component which provides web browsers and mobile applications with real-time communication (RTC) via simple APIs, which supports stress or audio or video data, the methods for working with them, the constraints associated with the type of data, the success and error callbacks when using the data asynchronously, the events that are fired during the process, and the like.

In additional embodiments, audio capturer 120 can further comprise an integrator further comprising a second application programming interface which can allow communication between the native browser communication collection feature and the multimodal input component 196.

FIG. 1 also depicts audio data sequence sender 130, which can send the audio data sequence, whether or not stored, to audio data sequence receiver 140 at a transcription workstation. There are many serial data transfer protocols (i.e., applications or devices to function as a data sequence sender). Protocols for serial data transfer can be grouped generally into two types, synchronous and asynchronous. For synchronous data transfer, both a sender and a receiver access the data according to the same time clock. In these exemplary embodiments, a special line for the clock signal is required. A master (or, optionally, a sender) provides the clock signal to all the receivers in the synchronous data transfer. In contrast, for exemplary embodiments of asynchronous data transfer, there is no common clock signal between the sender and receivers. Therefore, in these exemplary embodiments, the sender and the receiver first need to agree on a data transfer speed. This speed generally does not change after the data transfer starts. Both the sender and receiver set up their own internal circuits to make sure that the data accessing follows that agreement. However, computing clocks can differ in accuracy. Although the difference is very small, it can accumulate fast and eventually cause errors in data transfer. This problem is solved by adding synchronization bits at the front, middle or end of the data. Since the synchronization can be done in a periodic, a receiver can correct the clock accumulation error. Synchronization information may be added to every byte of data, or optionally, to every frame of data. Sending these extra synchronization bits may account for up to 50% data transfer overhead and hence slows down the actual data transfer rate.

In this exemplary embodiment, audio data sequence sender 130 is contemplated to write data to a socket, which can generally be defined as a one-to-one network connection. Thereafter, the transport layer may wrap the audio data sequence in a segment and “hand” it to the network layer, which will thereafter route this audio data sequence receiver 140 at a transcription workstation. Optionally, on the other side of this communication, the network layer will deliver the audio data sequence to the transport control protocol (TCP), which can make it “available” to audio data sequence receiver 140 as an exact copy of the data sent, i.e., TCP will not deliver packets out of order, and will wait for a retransmission in case it notices a gap in the byte stream.

Audio data sequence receiver 140 is generally defined as the computing element on the receiving end of a communication channel, i.e., the socket or connection in which the audio data sequence is transmitted. Audio data sequence receiver 140 can receive encrypted data from audio data sequence sender 130. Additional embodiments are contemplated where audio data sequence receiver 140 is modeled so as to include a decryption or decoding element.

The transcription workstation is commonly characterized as an area with equipment for the performance of a specialized task usually by a single individual or an intelligent terminal or personal computer usually connected to a computer network, i.e., a powerful microcomputer used especially for a specific task, in these exemplary embodiments, transcription.

In additional embodiments, audio data sequence sender 130 can further comprise an encryptor which can encrypt, i.e., encipher or encode, the audio data sequence prior to sending to audio data sequence receiver 140. Encryption via an encryptor commonly represented as a process of encoding a message or information in such a way that only authorized parties can access it and those who are not authorized cannot. Encryption generally does not itself prevent interference but denies the intelligible content to a would-be interceptor. In an exemplary embodiment of an encryption scheme, the intended information or message, referred to as plaintext (and as in the specific example of FIG. 1, the audio data sequence), is encrypted using an encryption algorithm generally known as a cipher generating “ciphertext” that can be read only if decrypted. Frequently, an encryption scheme uses a pseudo-random encryption key generated by an algorithm. It is in principle possible to decrypt the message without possessing the key, but, for a well-designed encryption scheme, considerable computational resources and skills are required. An authorized recipient, in one example audio sequence receiver 140, may decrypt the message with the key provided by the originator, i.e., audio data sequence sender 130, to recipients but not to unauthorized users.

In another example, public-key cryptography, or asymmetric cryptography, is generally considered a cryptographic system that uses pairs of keys: public keys which may be disseminated widely, and private keys which are known only to the owner. This accomplishes two functions: authentication, where the public key verifies that a holder of the paired private key sent the message, and encryption, where only the paired private key holder can decrypt the message encrypted with the public key. In a public key encryption system, any person can encrypt a message using the receiver's public key. That encrypted message can only be decrypted with the receiver's private key. The strength of a public key cryptography system relies on the computational effort (work factor in cryptography) required to find the private key from its paired public key. Effective security only requires keeping the private key private; the public key can be openly distributed without compromising security.

Another example includes a public key signature system, where a person can combine a message with a private key to create a short digital signature on the message. Anyone with the corresponding public key can combine a message, a putative digital signature on it, and the known public key to verify whether the signature was valid, i.e. made by the owner of the corresponding private key. In a secure signature system, it is computationally infeasible for anyone who does not know the private key to deduce it from the public key or any number of signatures or to find a valid signature on any message for which a signature has not hitherto been seen. Thus the authenticity of a message can be demonstrated by the signature, provided the owner of the private key keeps the private key secret.

In addition to protecting message integrity and confidentiality, authenticated encryption can provide plaintext awareness and security against chosen ciphertext attacks. In these attacks, an adversary attempts to gain an advantage against a cryptosystem (e.g., information about the secret decryption key) by submitting carefully chosen ciphertexts to some “decryption oracle” and analyzing the decrypted results. Authenticated encryption schemes can recognize improperly-constructed ciphertexts and refuse to decrypt them. Implemented correctly, this removes the usefulness of the decryption oracle, by preventing an attacker from gaining useful information that he does not already possess.

Audio data sequence player 150 as illustrated in FIG. 1 can play the audio data sequence at the transcription workstation and a transcriber can transcribe the audio data sequence into a written data sequence by employing or engaging with audio data sequence player 150. Audio data sequence player 150 can be any form of a portable media player (PMP), a digital audio player (DAP), or software simulating these functions instead of in device form, capable of storing and playing digital media such as audio, images, and video files. The audio data sequence is typically stored on a CD, DVD, flash memory, microdrive, hard drive, or similar memory device. Further embodiments are contemplated where streaming instead of storage is accomplished, i.e., an audio data sequence may be streamed directly from audio data sequence sender 230.

A transcriber commonly is a person who transcribes audio data sequences to written data sequences. However, in additional contemplated embodiments, a transcriber may also be a tool for the transcription and annotation of speech signals, which can optionally support multiple hierarchical layers of segmentation, named entity annotation, speaker lists, topic lists, overlapping speakers, and the like. In these exemplary embodiments, it is further contemplated that at least one, one or more, or a plurality of views of the sound pressure waveform at different resolutions may be viewed individually or simultaneously. Additionally, various character encodings, including Unicode, can be supported.

A written data sequence is ordinarily construed as a series of data packets that comprise any sequence of one or more symbols given meaning by specific act(s) of interpretation. A written data sequence (or datum, i.e., a single unit of data) generally requires interpretation to become information. To translate data into information, there must be several known factors considered. The factors generally involved are determined by the creator of the data and the desired information. The term “metadata” can be used to reference the data about the data. Metadata may be implied, specified or given. Data relating to physical events or processes will also have a temporal component. In almost all cases this temporal component is implied. Data representing quantities, characters, symbols, or the like on which operations are performed by a computing device can be stored and recorded on magnetic, optical, or mechanical recording media, and transmitted in the form of digital electrical signals.

In additional embodiments, the transcriber can receive as part of the audio data sequence a visual form dictated, i.e., a visual image in addition to audio data, by the series of data elements that uniquely identify the phonetic session. A visual form, in contrast to an audio form, can be data in a format which can be viewed, as compared to heard, played, or listened to. Further additional embodiments are contemplated where the transcriber can transcribe the audio data sequence into a written data sequence in an asynchronous manner. In this case, to transcribe is generally defined as making a written copy, especially a typewritten copy, of audio material. For purposes of this specification and the claims, asynchronous manner may be generally defined as not occurring at the same time (of a computer or other electrical machine); having each operation started only after the preceding operation is completed or relating to operation without the use of fixed time intervals. Generally, asynchronous communication is the transmission of data, generally without the use of an external clock signal, where data can be transmitted intermittently rather than in a steady stream. Any timing required to recover data from the communication symbols is encoded within the symbols. The most significant aspect of asynchronous communications is that data is not transmitted at regular intervals, thus making possible variable bit rate and that the transmitter and receiver clock generators do not have to be exactly synchronized all the time. In asynchronous transmission, data is sent one byte at a time and each byte is preceded by a start bit and a stop bit. It should be noted that in the exemplary embodiment and additional embodiments contemplated herein, in addition to those illustrated in FIGS. 2 and 3, that the inventive concept underlying phonetic representor 100 is based on functional operability throughout the elements in an asynchronous manner.

In FIG. 1, written data sequence sender 160 can send the written data sequence from the transcription workstation to written data sequence receiver 170 at the application. Written data sequence sender 160 may optionally employ one of a plurality of serial data transfer protocols to send the written data sequence. These protocols for serial data transfer can be grouped into two types: synchronous and asynchronous, as described above in reference to audio data sequence sender 130.

Written data sequence receiver 170 is commonly characterized as the computing element on the receiving end of a communication channel, i.e., the socket or connection in which the written data sequence is transmitted. Written data sequence receiver 170 can receive encrypted data from the written data sequence sender 160. Additional embodiments are contemplated where written data sequence receiver 170 is modeled so as to include a decryption or decoding element, as described above with reference to the encryptor.

In additional embodiments, written data sequence can be transmitted by written data sequence sender 170 in the same format and order as if entered into the application directly by the user in that format and order. In yet still additional embodiments, written data sequence sender 170 can further comprise a second encryptor which can encrypt the written data sequence prior to sending to written data sequence receiver 170.

Populator 180 as illustrated in FIG. 1 can analyze the received written data sequence and via incorporator 182 can incorporate the written data sequence at the application. Populator 180 can typically be exemplified as the computing component of the phonetic representor which analyzes a received written data sequence, determines its contents based on a number of variables, including but not limited to, a series of unique identifiers, which then displays (i.e., populates) the written data sequence in the context and format required by an application into which populator 180 is adding the written data sequence. In these exemplary embodiments, analyzing is generally defined as separating data, i.e., a written data sequence, into constituent parts or elements; determining the elements or essential features of the written data sequence (opposed to autonomously synthesizing or creating); so as to bring out the essential elements.

Incorporator 182 puts or introduces into an application the integral part or parts of the written data sequence, i.e., forms or combines into one body or uniform text. In additional embodiments, populator 180 can analyze the written data sequence at the application based on a mapping feature of the application. In computing and data management, a data mapping feature can generally be embodied as a process of creating data element mappings between two distinct data models. Data mapping is used as a first step for a wide variety of data integration tasks, including but not limited to, data transformation or data mediation between a data source and a destination, identification of data relationships as part of data lineage analysis, discovery of hidden sensitive data such as the last four digits of a social security number hidden in another user identification as part of a data masking, de-identification project, consolidation of multiple databases into a single database, and identifying redundant columns of data for consolidation or elimination, or the like.

In additional embodiments, populator 180 can analyze the written data sequence at the application based on the context that uniquely identifies, i.e., employing a unique identifier associated with the specific application, the phonetic session. In computing, a task context is generally known as the minimal set of data used by a task (e.g., process, thread, data sequence, or the like) that must be saved to allow a task to be interrupted, and later continued from the same point. The concept of context generally assumes being interrupted, the processor saves the context and proceeds to serve the interrupted service routine. Thus, the smaller the context is, the smaller the latency is. Context data may be located in processor registers, memory used by the task, in control registers used by some operating systems to manage the task, or the like.

Alternatively, context awareness is a property of computing devices that are characterized complementarily to location awareness. Whereas location may determine how certain processes around a contributing device operate, the context may be applied more flexibly. Context awareness originated as a term from ubiquitous computing or as so-called pervasive computing which sought to deal with linking changes in the environment with computer systems, which are otherwise static. The term has also been applied to business theory in relation to contextual application design and business process management issues.

Lastly, as illustrated in FIG. 1, controller 190 can be illustrated as, but is not limited to, a chip, an expansion card, stand-alone device, or the like that interfaces with other computing elements or with a peripheral device. Controller 190 can optionally be a link between two parts of a computer (for example a memory controller that manages access to memory for the computer) or a controller on an external device that manages the operation of (and connection with) that device. Additional embodiments are further contemplated where controller 190 is a device by which a user controls the operation of the computing device, such as with a handheld controller. Additional exemplary embodiments of controller 190 further include a plug-in board, a single integrated circuit on the motherboard, an external device, a separate device attached to a socket or channel, a separate device integrated into a peripheral device, or the like.

Controller 190 can further comprise an operating system 192, a coupler 194, and a multimodal input component 196.

Operating system 192 can direct and control the operation and function of phonetic representor 100 via a network. Operating system 192 can be considered a central processing unit (CPU), i.e., the electronic circuitry within a computing device that carries out the instructions of an application by performing the basic arithmetic, logical, control and input/output (I/O) operations specified by the instructions. The executable instructions can generally be kept in some kind of memory. Operating system 192 directs and controls phonetic representor 100 by managing or guiding by executable instruction, etc.; to regulate the course of; control; to administer; manage; supervise; to exercise direction over operation and function of phonetic representor 100, i.e., acts or instances, processes, manners of functioning or operating; states of being operative, performing specified actions or activities of phonetic representor 100, and the like.

As used generally herein, a network is a system of interconnected computing devices, nodes, and/or assets. In one example, a network includes the Internet that is a global system of interconnected computers that use the standard Internet protocol suite to serve users worldwide with an extensive range of information resources and services. It will be understood that the term Internet, in reality, is actually a network of networks consisting of millions of private, public, academic, business, and government networks, of local to global scope, that are linked by a broad array of electronic, wireless, and optical technologies. As referred to herein, nodes generally connect to networks, and networks may comprise one or more nodes.

Coupler 196 can operatively couple graphical controller 110, audio capturer 120, audio data sequence sender 130, audio data sequence receiver 140, written data sequence sender 160, written data sequence receiver 170, and populator 180, via a network and a gateway. Coupler 196 operatively couples the exemplary components via the computing concept of coupling, generally characterized as the degree of interdependence between computing modules, i.e., a measure of how closely connected two routines or modules are or the strength of the relationships between elements.

Coupling is usually contrasted with cohesion. Coupling can be “low” (i.e., “loose” and “weak”) or “high” (i.e., “tight” and “strong”). Examples of coupling include but are not limited to procedural programming, content coupling, common coupling, external coupling, control coupling, stamp coupling, data coupling, subclass coupling, temporal coupling, and the like.

Procedural programming refers to a subroutine of any kind, i.e. a set of one or more statements having a name and preferably its own set of variable names. Whereas content coupling is said to occur when one module uses the code of other module, for instance, a branch. Common coupling generally occurs when several modules have access to the same global data. External coupling occurs when two modules share an externally imposed data format, communication protocol, device interface, or the like, basically related to the communication to external tools and devices. Control coupling is one module controlling the flow of at least one other, one or more, or a plurality of modules by passing it information on what to do (e.g., passing a “what-to-do flag”). Stamp coupling occurs when modules share a composite data structure and use only parts of it, possibly different parts (e.g., passing a whole record to a function that needs only one field of it). Data coupling occurs when modules share data through, for example, parameters; in this sense, each datum is an elementary piece, and these are the only data shared (e.g., passing an integer to a function that computes a square root). Subclass coupling describes the relationship between a child and its parent, i.e., the child is connected to its parent, but the parent is not connected to the child. Temporal coupling can occur where two actions are bundled together into one module just because they happen to occur at the same time.

In computing, the term gateway often refers to a piece of networking hardware, including but not limited to a network node equipped for interfacing with another network that uses different protocols, devices such as protocol translators, impedance matching devices, rate converters, fault isolators, or signal translators as necessary to provide system interoperability, protocol translation/mapping interconnection between networks with different network protocol technologies by performing the required protocol conversions, and the like.

A further example of a gateway component comprises computer devices or applications configured to perform the tasks of a gateway. Gateways may optionally be known as protocol converters and may operate at any network layer. The activities of a gateway are more complex than that of the router or switch as it communicates using more than one protocol. A gateway is an essential feature of most routers, although other devices (such as any computing device or server) can function as a gateway.

Multimodal input component 196 can receive a multimodal input from the user via the network, upon triggering of phonetic representor 100. Multimodal input component 196 can consist of any one or a combination of device hardware used by a user to communicate with phonetic representor 100. In exemplary embodiments, multimodal input component 196 can comprise but is not limited to a keyboard, computer mouse, a modem, a network cards, typically perform both input and output operations.

The designation of a device as either input or output depends on perspective. Mouse and keyboards take physical movements that a human user outputs and convert them into input signals that a computing device can understand; the output from these devices is the computer's input. Similarly, printers and monitors take signals that a computer outputs as input and then convert these signals into a representation that human users can understand. From a human user's perspective, the process of reading or seeing these representations is receiving input; this type of interaction between computers and humans is studied in the field of human-computer interaction. Likewise, in computer architecture, the combination of the CPU and main memory, such as operating system 192, to which the CPU can read or write directly using individual instructions, is considered the controlling element of the architecture. Any transfer of information to or from the CPU/memory combo, for example by reading data from a disk drive, is considered input/output (I/O). The CPU and its supporting circuitry may provide memory-mapped I/O that is used in low-level computer programming, such as in the implementation of device drivers, or may provide access to I/O channels. An I/O algorithm is one which may optionally be designed to exploit locality and perform efficiently when exchanging data with a secondary storage device, such as a disk drive.

Generally, an I/O interface is required whenever the I/O device is driven by a processor. Typically a CPU communicates with devices via a bus. The interface must have the necessary logic to interpret the device address generated by the processor. If different data formats are being exchanged, the interface must be able to convert serial data to parallel form and vice versa. A computer that uses memory-mapped I/O accesses hardware by reading and writing to specific memory locations, using the same assembly language instructions that computer would normally use to access memory. An alternative method is via instruction-based I/O which requires that a CPU have specialized instructions for I/O. Both input and output devices have a data processing rate that can vary greatly. With some devices able to exchange data at very high speeds direct access to memory (DMA) without the continuous aid of a CPU is required.

Higher-level operating system and programming facilities employ separate, more abstract I/O concepts and primitives. For example, most operating systems provide application programs with the concept of files, traditionally abstract files, and devices as streams, which can be read or written, or sometimes both. An alternative to special primitive functions is the I/O monad, which permits programs to just describe I/O, and the actions are carried out outside the program. This is notable because the I/O functions would introduce side-effects to any programming language, but this allows purely functional programming to be practical.

In its most basic sense, multimodal input is communication and social semiotics. Multimodality describes communication practices in terms of the textual, aural, linguistic, spatial, visual resources, and the like, considered “modes” used to contemporize and compose messages. A mode can optionally be defined as a socially and culturally shaped resource for making meaning. Image, writing, layout, speech, moving images are examples of different modes. A mode may also be optionally defined as a resource shaped by both the intrinsic characteristics and potentialities of the medium and by the requirements of its use. For example, breaking down writing into its modal resources would be syntactic, grammatical, lexical resources and graphic resources. Likewise, graphic resources can be broken down into font size, type, and the like. Modes shape and are shaped by the systems in which they participate. Modes may aggregate into multimodal ensembles, shaped over time into familiar cultural forms, a good example being film, which combines visual modes, modes of dramatic action and speech, music and other sounds, i.e., multimodal.

A medium is a substance in which meaning is realized and through which it becomes available to others. Mediums may include but are not limited to, video, image, text, audio, and the like. Multimodality makes use of the electronic medium by creating digital modes with the interlacing of image, writing, layout, speech, video and the like. Mediums have become modes of delivery that take the current and future contexts into consideration. Multimodality can be used to increase user satisfaction by providing multiple platforms during one interaction.

FIG. 2 illustrates one exemplary system 200 comprising as one element phonetic representor illustrated in FIG. 1 (phonetic representor 100 in FIG. 1; phonetic representor 202 in FIG. 2). System 200 can further comprise an at least one user device 298, an at least one application 212, an at least one transcription workstation 254, an at least one transcriber 297, and a network 298.

In FIG. 2, at least one user device 298 can generally be considered as any end user device, such as, in example only no way in limitation, a personal computer (desktop or laptop), consumer device (e.g., personal digital assistant (PDA), tablet, smartphone, etc.), removable storage media (e.g., USB flash drive, memory card, external hard drive, writeable CD or DVD, etc.), or the like, which can store information.

The at least one application 212 as illustrated in FIG. 2 can, as described above, be a computer program designed to perform a group of coordinated functions, tasks, or activities for the benefit of the user, i.e., the end user operating at least one user device 298. Examples of an application include a word processor, a spreadsheet, an account application, a web browser, a media player, a console game, a photo editor, and the like. The collective noun application software refers to all applications collectively. This contrasts with system software, which is mainly involved in running computing hardware. Applications may be bundled with the computer and its system software or published separately and may be coded as proprietary, open source, and/or a combination. In this exemplary embodiment, a user, via user device 298 can initiate a phonetic session by activating graphical controller 210 integrated into application 212. At least one application 212 can optionally be bundled with the software of at least one user device 298 or published separately, stored in a cloud storage element, and accessible to a user via at least one user device 298.

System 200 illustrated in FIG. 2 further includes at least one transcription workstation 254 coupled to the system. At least one transcription workstation 254, as discussed above, can be any area with equipment for the performance of a specialized task usually by a single individual or an intelligent terminal or personal computer usually connected to a computer network, i.e., a powerful microcomputer used especially for a specific task, here, transcription, generally by a transcriber, such as for example, at least one transcriber 297.

As a functional element of system 200 illustrated at least one transcriber 297 operates at least one transcription workstation 254. At least one transcriber 297 can optionally be the person who transcribes audio data sequences to written data sequences, but may also be a tool for the transcription and annotation of speech signals for linguistic research, which can support multiple hierarchical layers of segmentation, named entity annotation, speaker lists, topic lists, and overlapping speakers. Two views of the sound pressure waveform at different resolutions may be viewed simultaneously. Various character encodings, including Unicode, can be supported.

Network 299 operates as a functional aspect of system 200 to allow the coupling, as defined above, of the various computing elements of the system and phonetic representor 202. As used throughout this specification and the claims, a network, i.e., network 299, can be any system of interconnected computing devices, nodes, and/or assets. In one example, a network includes the Internet that is a global system of interconnected computers that use the standard Internet protocol suite to serve users worldwide with an extensive range of information resources and services. It will be understood that the term Internet, in reality, is actually a network of networks consisting of millions of private, public, academic, business, and government networks, of local to global scope, that are linked by a broad array of electronic, wireless and optical technologies. As referred to herein, nodes generally connect to networks, and networks may comprise one or more nodes.

As illustrated as part of system 200 in FIG. 2, phonetic representor 202 comprises a graphical controller 210 used to initiate a phonetic session at an application 212 via user device 298, an audio capturer 220 which initiates and stores a recording of the phonetic session, i.e., the audio data sequence, an audio data sequence sender 230 to send the audio data sequence to an audio data sequence receiver 240 at a transcription workstation 254, an audio data sequence player 250 for playing the one audio data sequence which the transcriber 297 transcribes into a written data sequence, a written data sequence sender 260 to send the written data sequence to a written data sequence receiver 270 at the application 212, a populator 280 which analyzes the written data sequence and incorporates it via an incorporator 282 at the application 212, and a controller 290 comprising an operating system 292 to direct and control the phonetic representor 202, a coupler 294 to connect the various elements via a gateway, and a multimodal input component 296 to receive input from the user. Elements of phonetic representor 202 are substantially similar in nature to those described in more detail with reference to phonetic representor 100 illustrated in FIG. 1, even though numbering may not be consistent throughout this specification. Redundant explanations and definitions are not included in this written description for ease of reading purposes only.

As stated above, via graphical controller 210, a user initiates the phonetic session by activating graphical controller 210 integrated at application 212. In additional embodiments, graphical controller 210 can further comprise a unique identifier collector, the unique identifier collector being able to collect a series of data elements that uniquely identify the phonetic session initiated at user device 298. Furthermore, the series of data elements optionally can further comprise a second data element which uniquely identifies a context of the phonetic session. Alternatively, the series of data elements can further comprise an application specific identifier which uniquely identifies the phonetic session. By preference, the series of data elements does not need to comprise any data elements which identify the user who initiates the phonetic session. In further contemplated embodiments, graphical controller 210 can optionally be integrated into application 212 via an application programming interface specific to application 212.

Audio capturer 220, likewise, can initiate and can store a recording 222 of the phonetic session. The phonetic session can comprise an audio data sequence. In additional embodiments, audio capturer 220 the audio capturer can further comprise an application programming interface which facilitates using a native browser communication collection feature. Additionally, audio capturer 220 can further comprise an integrator further comprising a second application programming interface which can allow communication between the native browser communication collection feature and the multimodal input component 296.

Audio data sequence sender 230 can send the audio data sequence to audio data sequence receiver 240 at transcription workstation 254. In additional embodiments, audio data sequence sender 230 can further comprise an encryptor which can encrypt the audio data sequence prior to sending it to audio data sequence receiver 240.

Transcriber 297 can play, via audio data sequence player 250 at transcription workstation 254, the audio data sequence and can transcribe the audio data sequence into a written data sequence. In additional embodiments, transcriber 297 can transcribe the audio data sequence into the written data sequence in an asynchronous manner. Alternately, transcriber 297 can receive as part of the audio data sequence a visual form dictated by the series of data elements that uniquely identify the phonetic session.

From transcription workstation 254, written data sequence sender 260 can send the written data sequence to written data sequence receiver 270 at application 212. In additional contemplated embodiments, the written data sequence can be transmitted by written data sequence sender 260 in the same format and order as if entered into application 212 directly by the user in that format and order.

Populator 280 can analyze the written data sequence and can incorporate via incorporator 182 the written data sequence at application 212. In additional embodiments, populator 280 can analyze the written data sequence at application 212 based on a mapping feature of application 212. Otherwise, in further contemplated embodiments, populator 280 can analyze the written data sequence at application 212 based on the context that uniquely identifies the phonetic session.

Controller 290 can further comprise operating system 292, coupler 294, and multimodal input component 296, each as discussed above with reference to FIG. 1 and operating system 192, coupler 194, and multimodal input component 196. As such, operating system 292 can, via network 299, direct and control the operation and function of system 200. Likewise, coupler 294 can operatively couple graphical controller 210, audio capturer 220, audio data sequence sender 230, audio data sequence receiver 240, written data sequence sender 260, written data sequence receiver 270, populator 280, application 212, and transcription workstation 254, via a gateway. Similarly, multimodal input component 296 can receive a multimodal input from the user operating user device 296 once system 200 is triggered.

Lastly, FIG. 3 illustrates a method 300 for transcribing an audio data sequence captured via a phonetic representor (such as, for example, phonetic representor 100 depicted in FIG. 1 or phonetic representor 202 included as an element of system 200 illustrated in FIG. 2). The steps of the method described below can occur in any functionally operable order, concurrently, simultaneously, or in any other synchronous or asynchronous manner which would optimally provide the desired accuracy and ease of use for a user. Redundant explanations and definitions are not included in this written description for ease of reading purposes only.

Method 300 starts at 302, and at 310 a user can activate a phonetic session, via a graphical controller, by clicking the graphical controller integrated into an application.

At 320, an audio data sequence can be recorded via an audio data capturer, which the audio capturer can initiate and store the recorded phonetic session comprising an at least one audio data sequence.

At 330, the audio data sequence can be sent, via an audio data sequence sender, to an audio data sequence receiver at a transcription workstation.

At 350, a transcriber can play the received audio data sequence, via an audio data sequence player, and thereafter transcriber the audio data sequence into a written data sequence.

At 360, the written data sequence can be sent, via a written data sequence sender, from the transcription workstation to a written data sequence receiver at the application.

At 380, the written data sequence can be populated at the application, via a populator. The populator can analyze the written data sequence and can incorporate the written data sequence at the application. The method thereafter ends at 304.

Additional embodiments are contemplated where the graphical controller can further comprise a unique identifier collector, the unique identifier collector being able to collect a series of data elements that uniquely identify the phonetic session initiated by the user. In these additional embodiments, the series of data elements can further comprise a second data element which uniquely identifies a context of the phonetic session or the series of data elements can further comprise an application specific identifier which uniquely identifies the phonetic session. In additional embodiments, the series of data elements does not comprise any data elements which identify the user who initiates the phonetic session.

Furthermore, in still additional embodiments, the graphical controller can be integrated into the application via an application programming interface specific to the application.

In yet still additional embodiments, the audio capturer can further an application programming interface which facilitates using a native browser communication collection feature or the audio capturer can further comprise an integrator further comprising a second application programming interface which can allow communication between the native browser communication collection feature and the multimodal input component. Likewise, in further embodiments, the audio data sequence sender can further comprise an encryptor which can encrypt the audio data sequence prior to sending to the audio data sequence receiver. Also, the written data sequence can be transmitted by the written data sequence sender in the same format and order as if entered into the application directly by the user in that format and order.

Optionally, in additional embodiments, the transcriber can receive as part of the audio data sequence a visual form dictated by the series of data elements that uniquely identify the phonetic session or the transcriber can transcribe the audio data sequence into the written data sequence in an asynchronous manner.

In additional exemplary embodiments, the populator can analyze the written data sequence at the application based on a mapping feature of the application or the populator can analyze the written data sequence at the application based on the context that uniquely identifies the phonetic session.

Additional methods, aspects, and elements of the present inventive concept are contemplated to be used in conjunction with, individually or in any combination thereof which will create a reasonably functional phonetic representor, system, and method for transcribing a phonetic session. It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement, and components shown and described above, but may be susceptible to numerous variations within the scope of the invention.

Moreover, particular exemplary features described herein in conjunction with specific embodiments or aspects of the present invention are to be construed as applicable to any embodiment described within, enabled through this written specification and claims, or apparent based on this written specification and claims. Thus, the specification and drawings are to be regarded in a broad, illustrative, and enabling sense, rather than a restrictive one. It should be understood that the above description of the embodiments of the present invention is susceptible to various modifications, changes, and adaptations, and the same are intended to be comprehended within the meaning and range of equivalents of the appended claims.

Therefore, what is claimed:

1. A phonetic representor, comprising:
a graphical controller, wherein a user initiates a phonetic session by activating the graphical controller integrated into an application;
an audio capturer, wherein the audio capturer initiates and stores an at least one recording of the phonetic session comprising an at least one audio data sequence;
an audio data sequence sender, wherein the at least one audio data sequence is sent to an audio data sequence receiver at a transcription workstation;
an audio data sequence player, wherein from the transcription workstation a transcriber plays the at least one audio data sequence and transcribes an at least one written data sequence;
a written data sequence sender, wherein the transcriber sends the at least one written data sequence from the transcription workstation to a written data sequence receiver at the application;
a populator, wherein the populator analyzes the at least one written data sequence and incorporates the at least one written data sequence at the application; and
a controller, further comprising:
an operating system, wherein, via a network, the operating system directs and controls the operation and function of the phonetic representor;
a coupler, wherein, via the network, the coupler operatively couples the graphical controller, the audio capturer, the audio data sequence sender, the audio data sequence receiver, the written data sequence sender, the written data sequence receiver, and the populator, via an at least one gateway; and
a multimodal input component, wherein, via the network, the multimodal input component receives a multimodal input from the user once the phonetic representor is triggered.

2. The phonetic representor of claim 1, wherein the graphical controller further comprises a unique identifier collector, wherein the unique identifier collector collects an at least one series of data elements that uniquely identify the phonetic session initiated by the user.

3. The unique identifier collector of claim 2, wherein the at least one series of data elements further comprises an at least one second series of data elements which uniquely identifies a context of the phonetic session.

4. The unique identifier collector of claim 2, wherein the at least one series of data elements further comprises an at least one application specific identifier which uniquely identifies the phonetic session.

5. The unique identifier collector of claim 2, wherein the at least one series of data elements does not comprise any series of data elements which identify the user who initiates the phonetic session.

6. The phonetic representor of claim 2, wherein the transcriber receives as part of the at least one audio data sequence a visual form dictated by the at least one series of data elements that uniquely identify the phonetic session.

7. The phonetic representor of claim 1, wherein the graphical controller is integrated into the application via an at least one application programming interface specific to the application.

8. The phonetic representor of claim 1, wherein the audio capturer further comprises an application programming interface which facilitates using a native browser communication collection feature.

9. The phonetic representor of claim 8, wherein the audio capturer further comprises an integrator further comprising an at least one second application programming interface which allows communication between the at least one native browser communication collection feature and the multimodal input component.

10. The phonetic representor of claim 1, wherein the audio data sequence sender further comprises an encryptor which encrypts the at least one audio data sequence prior to sending to the audio data sequence receiver.

11. The phonetic representor of claim 1, wherein the transcriber transcribes the at least one audio data sequence into the at least one written data sequence in an asynchronous manner.

12. The phonetic representor of claim 1, wherein the populator analyzes the at least one written data sequence and further formats the at least one written data sequence for consumption and integration by an at least one external system, a second application, or a data source.

13. The phonetic representor of claim 1, wherein the populator analyzes the at least one written data sequence at the application based on a mapping feature of the application.

14. The phonetic representor of claim 3, wherein the populator analyzes the at least one written data sequence at the application based on the context that uniquely identifies the phonetic session.

15. The phonetic representor of claim 1, wherein the at least one written data sequence is transmitted by the written data sequence sender in the same format and order as if entered into the application directly by the user in that format and order.

16. A system, comprising:
an at least one user device;
an at least one application;
an at least one transcription workstation;
an at least one transcriber;
a network; and
a phonetic representor, wherein the phonetic representor further comprises:
a graphical controller, wherein a user initiates a phonetic session by activating the graphical controller integrated into the at least one application;
an audio capturer, wherein the audio capturer initiates and stores an at least one recording of the phonetic session comprising an at least one audio data sequence;
an audio data sequence sender, wherein the at least one audio data sequence is sent to an audio data sequence receiver at the transcription workstation;
an audio data sequence player, wherein from the transcription workstation the transcriber plays the at least one audio data sequence and transcribes an at least one written data sequence;
a written data sequence sender, wherein the transcriber sends the at least one written data sequence from the transcription workstation to a written data sequence receiver at the at least one application;
a populator, wherein the populator analyzes the at least one written data sequence and incorporates the at least one written data sequence at the at least one application; and
a controller, further comprising:
an operating system, wherein, via the network, the operating system directs and controls the operation and function of the phonetic representor;
a coupler, wherein, via the network, the coupler operatively couples the graphical controller, the audio capturer, the audio data sequence sender, the audio data sequence receiver, the written data sequence sender, the written data sequence receiver, the populator, the at least one application, the at least one transcription workstation, and the at least one transcriber, via an at least one gateway; and
a multimodal input component, wherein, via the network, the multimodal input component receives a multimodal input from the user once the phonetic representor is triggered.

17. The system of claim 16, wherein the graphical controller further comprises a unique identifier collector, wherein the unique identifier collector collects an at least one series of data elements that uniquely identify the phonetic session initiated by the user.

18. The system of claim 17, wherein the at least one series of data elements further comprises an at least one second data element which uniquely identifies a context of the phonetic session.

19. The system of claim 17, wherein the at least one series of data elements further comprises an at least one application specific identifier which uniquely identifies the phonetic session.

20. The system of claim 17, wherein the at least one series of data elements does not comprise any data elements which identify the user who initiates the phonetic session.

21. The system of claim 17, wherein the at least one transcriber receives as part of the at least one audio data sequence a visual form dictated by the at least one series of data elements that uniquely identify the phonetic session.

22. The system of claim 16, wherein the graphical controller is integrated into the at least one application via an at least one application programming interface specific to the application.

23. The system of claim 16, wherein the audio capturer further comprises an application programming interface which facilitates using a native browser communication collection feature.

24. The system of claim 23, wherein the audio capturer further comprises an integrator further comprising an at least one second application programming interface which allows communication between the at least one native browser communication collection feature and the multimodal input component.

25. The system of claim 16, wherein the audio data sequence sender further comprises an encryptor which encrypts the at least one audio data sequence prior to sending to the audio data sequence receiver.

26. The system of claim 16, wherein the transcriber transcribes the at least one audio data sequence into the at least one written data sequence in an asynchronous manner.

27. The system of claim 16, wherein the populator analyzes the at least one written data sequence and further formats the at least one written data sequence for consumption and integration by an at least one external system, a second application, or a data source.

28. The system of claim 16, wherein the populator analyzes the at least one written data sequence at the application based on a mapping feature of the at least one application.

29. The system of claim 16, wherein the populator analyzes the at least one written data sequence at the application based on the context that uniquely identifies the phonetic session.

30. The system of claim 16, wherein the at least one written data sequence is transmitted by the written data sequence sender in the same format and order as if entered into the at least one application directly by the user in that format and order.

31. A method for transcribing an at least one audio data sequence captured via a phonetic representor, comprising:
a user activating, via a graphical controller, a phonetic session by clicking the graphical controller integrated into an application;
recording the at least one audio data sequence, via an audio capturer, the audio capturer initiates and stores the recorded phonetic session comprising the at least one audio data sequence;
sending the at least one audio data sequence, via an audio data sequence sender, wherein the at least one audio data sequence is sent to an audio data sequence receiver at a transcription workstation;
playing the received at least one audio data sequence, via an audio data sequence player, wherein from the audio data sequence receiver at the transcription workstation a transcriber plays the at least one audio data sequence and transcribes the at least one audio data sequence into an at least one written data sequence;
sending the at least one written data sequence, via a written data sequence sender, wherein the transcriber sends the at least one written data sequence from the transcription workstation to a written data sequence receiver at the application; and
populating the at least one written data sequence at the application, via a populator, wherein the populator analyzes the at least one written data sequence and incorporates the at least one written data sequence at the application.

32. The method of claim 31, wherein the graphical controller further comprises a unique identifier collector, wherein the unique identifier collector collects an at least one series of data elements that uniquely identify the phonetic session initiated by the user.

33. The method of claim 32, wherein the at least one series of data elements further comprises an at least one second series of data elements which uniquely identifies a context of the phonetic session.

34. The method of claim 32, wherein the at least one series of data elements further comprises an at least one application specific identifier which uniquely identifies the phonetic session.

35. The method of claim 32, wherein the at least one series of data elements does not comprise any series of data elements which identify the user who initiates the phonetic session.

36. The method of claim 32, wherein the transcriber receives as part of the at least one audio data sequence a visual form dictated by the at least one series of data elements that uniquely identify the phonetic session.

37. The method of claim 31, wherein the graphical controller is integrated into the application via an at least one application programming interface specific to the application.

38. The method of claim 31, wherein the audio capturer further comprises an application programming interface which facilitates using a native browser communication collection feature.

39. The method of claim 38, wherein the audio capturer further comprises an integrator further comprising an at least one second application programming interface which allows communication between the at least one native browser communication collection feature and the multimodal input component.

40. The method of claim 31, wherein the audio data sequence sender further comprises an encryptor which encrypts the at least one audio data sequence prior to sending to the audio data sequence receiver.

41. The method of claim 31, wherein the transcriber transcribes the at least one audio data sequence into the at least one written data sequence in an asynchronous manner.

42. The method of claim 31, wherein the populator analyzes the at least one written data sequence and further formats the at least one written data sequence for consumption and integration by an at least one external system, a second application, or a data source.

43.

44. The method of claim 31, wherein the populator analyzes the at least one written data sequence at the application based on a mapping feature of the application.

45. The method of claim 33, wherein the populator analyzes the at least one written data sequence at the application based on the context that uniquely identifies the phonetic session.

46. The method of claim 31, wherein the at least one written data sequence is transmitted by the written data sequence sender in the same format and order as if entered into the application directly by the user in that format and order.
